(19) United States
(12) Patent Application Publication
(10) Pub. No.: US 2008/0298940 A1
(43) Pub. Date: Dec. 4, 2008

(54) BED CONVEYOR APPARATUS FOR ASSISTING IN UNLOADING A VEHICLE

(75) Inventors: John Cleasby, Palo Alto, CA (US); Darren DeGraw, West Haven, UT (US)

Correspondence Address: WORKMAN NYDEGGER, 60 EAST SOUTH TEMPLE, 1000 EAGLE GATE TOWER, SALT LAKE CITY, UT, 84111, US

(73) Assignee: Cleasby Conveyors, Clearfield, UT (US)

(21) Appl. No.: 11/756,369

(22) Filed: May 31, 2007

(51) Int. Cl. B65G 67/08

(52) U.S. Cl. 414/398

(57) ABSTRACT

A bed conveyor for use in a truck used to transport palletized loads of stacked packages and for delivering the packages (e.g., by means of an overhead conveyor) to a location remote from the truck (e.g., a roof top). The bed conveyor comprises a plurality of rails that extent longitudinally along the bed floor of the truck, which rails define a top weight bearing surface for supporting the weight of the palletized loads of stacked packages. The bed conveyor also includes a pusher member at least partially disposed above the top surface of the rails, and drive means for driving the pusher member and the palletized load rearwardly on the rails of the truck bed. The truck may also include a lift platform rearward relative to the bed conveyor for raising the palletized loads off the truck bed for easier unloading onto the overhead conveyor.

### BACKGROUND OF THE INVENTION

1. The Field of the Invention

The present invention relates to a conveyor apparatus for use on a vehicle such as a truck designed to transport and deliver palletized loads of stacked packages. In particular, the bed conveyor apparatus is useful in the transporting and delivery of packages of roofing materials, such as shingles, directly to the site of their application, e.g., on a building roof.

2. The Relevant Technology

Various types of delivery trucks of the self-unloading type are used to transport roofing materials to a building site. In general, vehicles presently in service are flat bed trucks fitted with a boom-like device. One such device can pick up full pallet loads of stacked roofing packages (such as shingles) from the vehicle bed and deposit the full load on the ground, adjacent the vehicle. Another device comprises a turret mounted boom-like overhead conveyor which can convey individual packages from a position at the conveyor turret to a site (e.g., a roof) remote from the vehicle bed. The first type of device handles full pallet loads, which are later broken down into individual packages and delivered to a roof or other site, for example, by use of a separate conveyor system, or even by manually unloading a pallet load either once it has been placed on the ground or even as it is held near the chosen site by the device. The swinging overhead conveyor requires the packages to be unloaded from palletized loads on the truck bed and carried to the discharge conveyor, where they are conveyed to the chosen delivery site, such as a roof.

In the turret supported overhead conveyor type device, a laborer (often the vehicle driver) must tote the individual packages from the pallets to the receiving end of the conveyor (typically located near the rear of the truck bed), requiring lifting of many heavy packages and carrying them at least part of the length of the vehicle bed, then placing them on the overhead conveyor. This sort of labor is quite strenuous, and the only mechanical assistance for the laborer is the overhead conveyor which carries the packages upward and outward of the vehicle bed to the rooftop or other chosen site. By way of example, individual packages of roofing shingles weigh on the order of 80 pounds each, and pallet loads range from about 2600 to 3000 pounds per loaded pallet. A loaded truck may often carry 6-12 or more loaded pallets, which represents a large amount of strenuous labor to move each package of each pallet manually.

It would be an improvement in the art to provide means for conveying the loaded pallets rearwardly towards the receiving end of the overhead conveyor to reduce the distance that the operator must manually haul each package from each pallet to the receiving end of the overhead conveyor. It would be particularly advantageous if such conveyor means were sufficiently sturdy to withstand the heavy loads (e.g., often up to and exceeding about 40,000 lbs) and regular use typical of such equipment. It would be a further improvement to provide an additional device that would reduce the amount of lifting required of each package, particularly for packages at the bottom of each pallet (i.e., a way to automatically lift the packages up near a height of the receiving end of the overhead conveyor), particularly if such a device included safety mechanisms for preventing foot injuries during operation of such a lift device.

### BRIEF SUMMARY OF THE PREFERRED EMBODIMENTS

In one aspect, the present invention is directed to a bed conveyor for use in a truck used to transport palletized loads of stacked packages and for delivering the packages (e.g., by means of an overhead conveyor) to a location remote from the truck (e.g., a roof top). The bed conveyor comprises a plurality of rails that extent longitudinally along the bed floor of the truck, which rails define a top weight bearing surface for supporting the weight of the palletized loads of stacked packages. The bed conveyor also includes a pusher member at least partially disposed above the top surface of the rails. The pusher member is selectively moveable between a first position near a first front end of the plurality of rails and a second position that is located rearwardly relative to the first position. The bed conveyor also includes drive means operatively coupled to the pusher member for selectively moving the pusher member from the first position to the second position. In operation, the pusher member engages the pallet or pallets located at the forward end of the truck bed, pushing them (and all the other pallets) rearwardly.

Any cables, belts, and/or chains which form part of the drive means are advantageously spaced apart (e.g., disposed below) from the top weight bearing surface of the plurality of rails so that the weight of the palletized loads of stacked packages is supported by the plurality of rails rather than directly on the chains, belts, or cables. This characteristic is particularly important as the load is in transit from the front towards the rear of the truck bed. Providing a conveyor system in which the weight of the load is born by the rails rather than by the chains, belts, or cables advantageously prevents fatigue and breakage of the cables, belts, and/or chains as a result of the relatively large weight of the load. In addition, the force required to overcome friction so as to slide the load rearwardly is significantly less than a force that would be needed to lift the load above the bed and then convey the heavy load rearwardly (e.g., on a series of cables, chains, or a conveyor belt disposed in or on the truck bed).

The drive means may comprise one or more cables, belts, and/or drive chains in combination with a hydraulic pump for driving the one or more chains, belts, and/or cables which are coupled to the pusher member. The inventors have discovered that a pair of heavy gauge logging drive chains work particularly well in that the chains are able to bear the force associated with engaging the pusher member so as to push the palletized load without breakage or fatigue of the chains, even after several months (or quite likely years based on testing) of continued use.

The chains run longitudinally parallel to the rails and may be disposed near the longitudinal center line of the bed floor. For example, four rails may be disposed roughly equidistant from one another on the bed floor, and the chains may run parallel to and between the two centrally disposed rails.

The hydraulic pump may provide power needed to meet the hydraulic requirements associated with the bed conveyor as well as one or more additional hydraulic devices (e.g., an overhead conveyor and/or a lifting platform). Advantageously, the pump may preferably be configured as a tandem pump capable of being selectively operated so as to move the pusher member (and thus the palletized loads) at a rate between about 10 and about 60 feet per minute, more preferably between about 15 and about 40 feet per minute, and most preferably between about 20 and about 30 feet per minute. A typical truck including the bed conveyor may have a bed length of about 24, 26, or 28 feet. The rates disclosed above advantageously allow for movement of the pallet load to a transfer station unloading area near the rear of the truck bed in about a minute or less. This rate of movement has been found to be particularly optimal as it allows for relatively quick movement of the pallets to the rear of the bed floor without being so fast as to present a danger to the worker. Once each pallet has been pushed to the transfer station unloading area at the rear of the bed floor they can be loaded onto an overhead conveyor for transport up to a roof top or other desired location.

In another aspect, the invention is directed to a truck including a bed conveyor as described above, an overhead conveyor and a lift disposed on or in the bed floor at a transfer station unloading area located near the rear of the bed floor at a location where individual packages may be unloaded from each pallet and placed onto the overhead conveyor. Such a lift includes a lift platform that is selectively movable from a lower position that is generally coplanar with the bed floor to a raised position above the bed floor, a lift mechanism disposed under the bed floor for moving the lift platform between its lower position and its raised position, and safety means for preventing injuries to an operator's appendages (e.g., particularly the operator's feet) while operating the lift. Such a lift is advantageous as it reduces the amount of vertical lifting required of an operator when unloading each pallet and placing the individual packages onto an overhead conveyor for transport to a roof top or other selected location. A further advantage of such a lift system is that it reduces the risk of foot or other injuries to the worker, which may otherwise pose a serious safety risk during operation as the lift is raised and lowered.

For example, an operator at the transfer station simply removes the packages from the palletized load one at a time in serial fashion and places them onto the overhead conveyor. As each palletized load is progressively emptied the lift platform can be raised so that the laborer has only to move the packages onto the overhead conveyor with minimal vertical lifting. In other words, the lift may be operated up or down to so that the packages to be unloaded are at approximately the same height as the location where the packages are placed onto the overhead conveyor. In addition, a rest may be provided near the transfer station or near the overhead conveyor to assist in this transferring action. Once a pallet has been fully unloaded it is set aside, the lift platform is lowered back to the level of the bed floor, and the pusher member is operated to push another pallet (or pair of pallets) onto the lift platform for unloading.

The lift platform advantageously includes a mechanism for preventing injuries to an operator's foot or other appendage as might otherwise occur while the lift is lowered, specifically in the event that an operator's foot, arm, or other appendage were to be disposed directly beneath the lift platform. In one embodiment, safety means for preventing injuries to the operator's foot or other appendage may comprise substantially vertical but inwardly beveled side walls disposed on the lift which side walls are configured so as to push an operator's foot or other appendage out of the way as the lift platform is lowered from a raised position to a lower position. In another embodiment safety means may alternatively or additionally comprise a sensor operatively coupled to the lift mechanism, the sensor being operative to stop downward movement of the lift platform in the event that an operator's foot or other appendage is identified by the sensor as being disposed in the downward path of the lift platform. Such safety mechanisms prevent an operator's foot, arm, or other appendage from becoming caught between the lift and the bed floor, which may otherwise result in serious injury to the operator.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a perspective view of a flat bed truck including a bed conveyor, an overhead conveyor, and a lift platform according to the present invention;

FIG. 2 is a rear perspective view of an exemplary bed conveyor;

FIGS. 3A-3B are schematic perspective views showing details of the bed conveyor of FIG. 2;

FIG. 4A is a close up perspective view of an exemplary lift platform in a partially raised position;

FIG. 4B is a side view of the lift platform of FIG. 4A;

FIG. 5A is a close up perspective view of the lift platform of FIG. 4A in a fully raised position;

FIG. 5B is a side view of the lift platform of FIG. 5A;

FIG. 6 illustrates exemplary foot pedal controls for controlling operation of the lift platform and bed conveyor;

FIG. 7 is a hydraulic control diagram; and

FIG. 8 shows a worker unloading packages from a pallet on the lift platform and placing the packages onto the overhead conveyor for transport to a rooftop.

### DETAILED DESCRIPTION OF THE PREFERRED EMBODIMENTS

### I. Introduction

In one aspect, the present invention is directed to a bed conveyor for use with a truck used to transport palletized loads of stacked packages (e.g., asphalt shingles) and for delivering the packages (e.g., by means of an overhead conveyor) to a location remote from the truck (e.g., a roof top). The bed conveyor comprises a plurality of rails that extend longitudinally along the bed floor of the truck. The top surfaces of the rails define a weight bearing surface for supporting the weight of the palletized loads of stacked packages. The bed conveyor also includes a pusher member disposed just above the top surface of the rails (e.g., about an inch or less above the top of the rails). The pusher member may be selectively activated (e.g., by foot pedals or other user controls) so as to move between a first position near a first front end of the plurality of rails to a second position that is located rearwardly relative to the first position.

The pusher member is operatively coupled to drive means including one or more drive chains, belts, or cables for effecting movement of the pusher member. The cables, belts, or drive chains, are advantageously spaced apart from the top weight bearing surface of the plurality of rails (e.g., chains may be disposed to the side of the rails, so as to be below the top of the rails) so that the weight of the palletized loads of stacked packages is supported by the plurality of rails rather than the cables, belts, or drive chains as the load is moved towards the rear of the truck bed. Such a configuration advantageously prevents premature fatigue and breakage of the cables and/or chains as a result of the relatively large weight of the load.

### II. A Truck Including an Exemplary Bed Conveyor

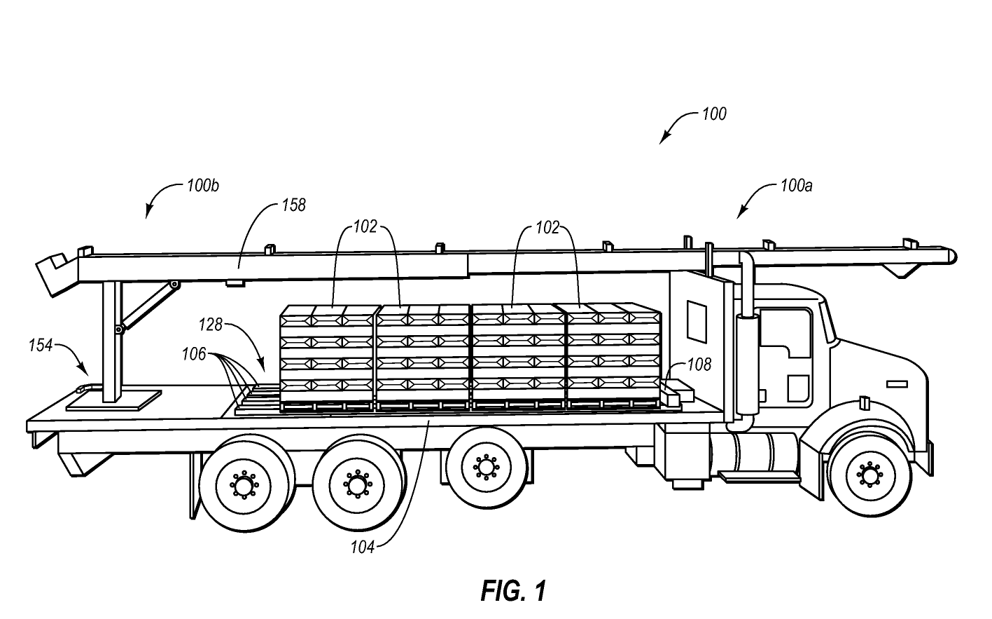

FIG. 1 illustrates a truck 100 including a load of palletized packages 102 that are loaded onto the bed portion 104 of truck 100. Bed portion 104 is advantageously substantially flat and may include a bed conveyor for selectively moving the palletized packages 102 rearwardly (i.e., from front end 100a of bed 104 towards rear end 100b of bed 104). Truck 100 also includes a lift platform 128 for lifting the pallets upwardly off bed 104, and an overhead conveyor 158 for conveying each individual package to a desired overhead location (e.g., onto a rooftop).

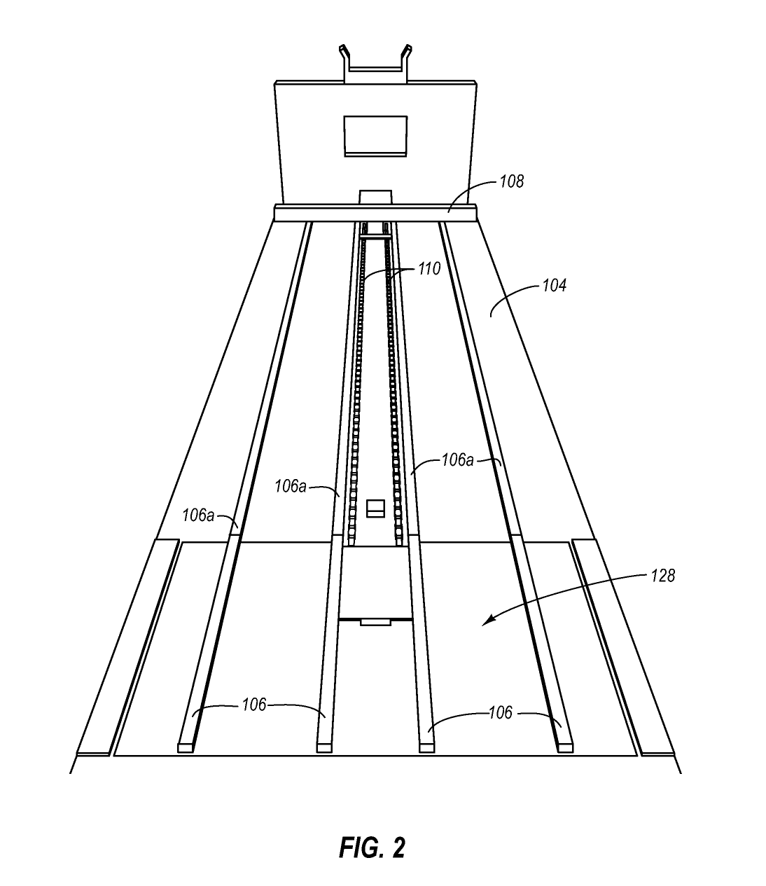

The bed conveyor includes a plurality (e.g., four) of longitudinally oriented rails 106 which are disposed on bed floor 104. Rails 106 extend from near the front of bed 104 to lift platform 128. In the illustrated embodiment, rails 106 also extend across lift platform 128. Rails 106 may be fastened to bed floor 104 by welding, bolts, or another fastener. The rails include a top surface 106a (FIG. 2) that supports the weight of loaded pallets 102. Each rail 106 may have a height, for example, of about 1 to 5 inches, preferably 2 to 3 inches, and a width of about 0.5 to 5 inches, preferably 1 to 3 inches. Because loaded pallets 102 contact only the top surfaces of rails 106, the friction resistance to sliding is lessened as compared to if the load were simply placed on the bed 104 so that the pallets contact bed 104 along their entire bottom surface. In addition, wear to bed 104 is significantly reduced, as contact is limited to top surface 106a of rails 106, which may be replaced more easily than entire bed 104, if needed. For this reason, it is preferable for rails 106 to extend across lift platform 128 also (so that wear to lift platform 128 below rails 106 is minimized). Of course, each rail is cut or otherwise separated at the forward edge of lift platform 128, as platform 128 must be able to move upwardly relative to bed floor 104 and the remainder of rails 106 which are fixed to bed floor 104.

A pusher member 108 is at least partially disposed just above (e.g., a bottom surface, or portion thereof, of pusher member 108 may be about an inch or less, more preferably less than about ¼ inch above) the top surface of rails 106. Pusher member 108 is illustrated as comprising a square or rectangular bar, for example formed of steel, although other shapes and/or materials may alternatively be used. In one example, pusher bar 108 has a cross section which is about 4 to 10 inches square, preferably about 6 to 8 inches square. Of course, a portion of the pusher member 108 (e.g., a portion of the bottom surface) can extend below and between the rails 106. Such extensions (not shown) may help to guide the pusher member so as to maintain a desired orientation (e.g., perpendicular) relative to bars 106.

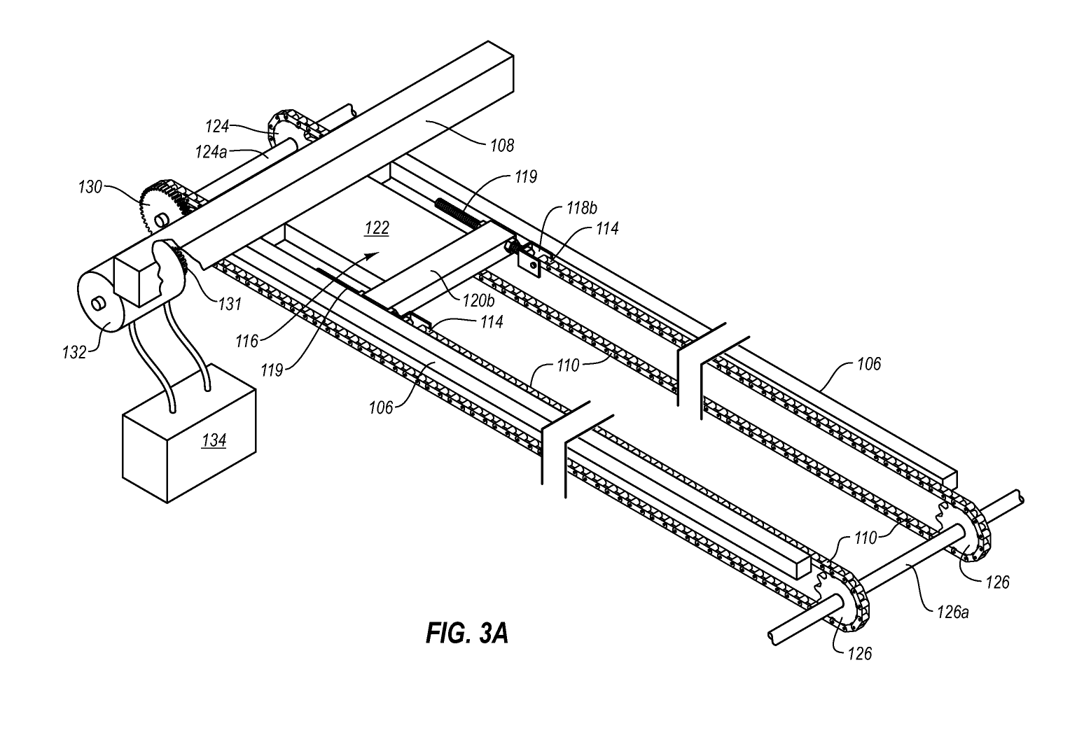

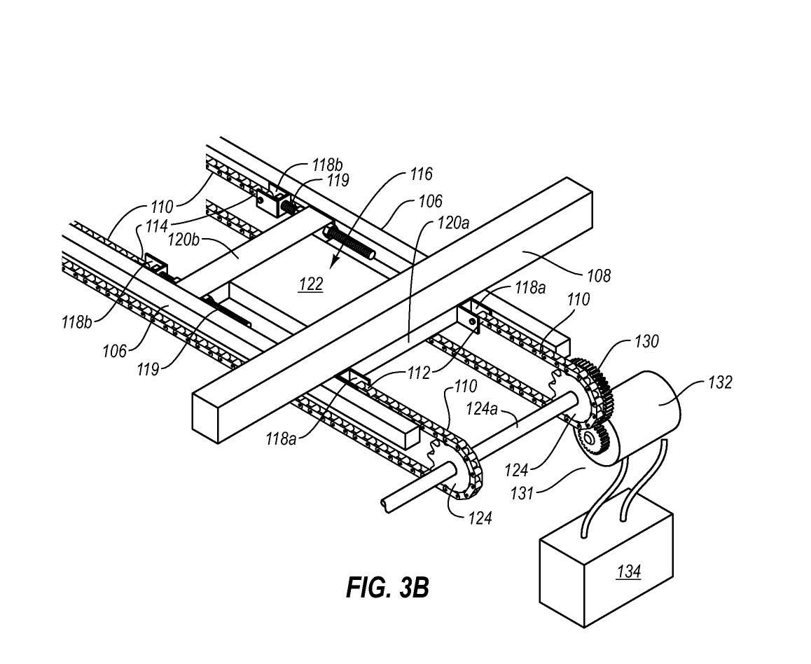

As shown in FIGS. 3A and 3B, pusher bar 108 is attached to stabilizer assembly 116, and power to move pusher bar 108 is provided by drive means to which the pusher bar 108 and/or stabilizer assembly 116 is operatively coupled. For example, as illustrated, drive chains 110 may be attached to brackets 118a and 118b which form part of stabilizer assembly 116. Chains 110 are in turn operatively coupled to a hydraulic pump by a series of sprockets, gears and shafts, as will be explained in further detail below.

As illustrated, a first end 112 of each chain 110 is connected to a forward bracket 118a. Each bracket 118a is welded or otherwise fastened to a forward stabilizer bar 120a, which bar is in turn welded or otherwise fastened to stabilizer block 122. Stabilizer assembly 116 further includes another oppositely disposed rear stabilizer bar 120b at the opposite end of block 122, a pair of tension adjustment bolts 119, and a pair of rear brackets 118b, to which the opposite end 114 of each chain 110 is connected. Each stabilizer bar 120 advantageously has a width only slightly (e.g., within about ¼ inch) less than the distance between innermost rails 106 (FIG. 3B). Such a configuration provides a degree of stability as pusher bar 108 and stabilizer assembly 116 are pulled rearwardly by chains 110, so that stabilizer assembly 116 slides between innermost rails 106 and pusher bar 108 moves rearwardly over all rails 106 during pushing of loaded pallets 102. In other words, stabilizer assembly 116 acts to keep pusher bar 108 substantially perpendicular to rails 106 and bed 104 during movement of pusher bar 108 and loaded pallets 102.

Tension adjustment bolts 119 allow for tightening or loosening of the tension on chains 110 over the life of the bed conveyor. Each threaded bolt 119 is illustrated as being mounted longitudinally through bracket 118b and rear stabilizer bar 120b, with a series of nuts appropriately disposed (e.g., on either side of bar 120b) for tightening or loosening tension on chain 110. Such an adjustment mechanism is particularly helpful as chains 110 tend to stretch somewhat after extended use, and bolts 119 allow a user to then tighten bolts 119 and the associated nuts so as to increase chain tension to a desirable level.

As perhaps best seen in FIGS. 3A and 3B, each chain 110 runs around a respective sprocket 124 near a front end of the bed 104, and each chain runs around another rearwardly located sprocket 126 disposed just forward of lift platform 128, where chains 110 drop below bed 104 and return back to the front of bed 104. Sprockets 124 are mounted in a spaced apart configuration in which each sprocket 124 is mounted on front shaft 124a. Similarly, sprockets 126 are mounted in a spaced apart configuration in which each sprocket 126 is mounted on rear shaft 126a. Power is delivered to frontwardly disposed shaft 124a and sprockets 124 through gear 130, which intermeshes with pinion gear 131. Gear 131 is coupled to gear box 132 which in turn is coupled to hydraulic pump 134.

Preferably, hydraulic pump 134 is a high capacity dual valve hydraulic pump, for example, capable of delivering hydraulic fluid at about 15 gpm on one side (or valve) and about 6 to 8 gpm on the second side (or valve). Power to run pusher member 108 and lift platform 128 is provided by the higher capacity side of pump 134. Power to pump 134 is provided by a power take-off from the truck's engine. The coupling of pusher member 108 and stabilizer block assembly 116 to the drive means (e.g., chains 110, and the series of gears, shafts, sprockets, and hydraulic pump) allows the user to activate pusher member 108 so as to allow for selective movement of pusher member 108 from a first position (e.g., near front end 100a of bed 104) to a second position (e.g., towards rear end 100b of bed 104, just in front of lift platform 128), pushing the loaded pallets rearwardly, so that one or a pair of loaded pallets are pushed onto platform 128 for lifting and unloading.

The tandem hydraulic pump 134 advantageously is capable of being selectively operated so as to move the pusher member 108 (and thus the palletized loads 102) at a rate between about 10 and about 60 feet per minute, more preferably between about 15 and about 40 feet per minute, and most preferably between about 20 and about 30 feet per minute. A typical truck including the bed conveyor may have a bed length of about 24, 26, or 28 feet. The rates disclosed above advantageously allow for movement of the pallet load to the lift platform 128 near the rear of the truck bed 104 in about a minute or less. This rate of movement has been found to be particularly beneficial as it allows for relatively quick movement of the pallets to the rear of the bed floor without being so fast as to present a danger to the worker.

Chains 110 are advantageously spaced apart from the top weight bearing surface 106a of the plurality of rails 106 so that the weight of the palletized load 102 is supported by the plurality of rails 106 rather than directly on chains 110. For example, they may be disposed to the inside of centrally located rails 106. This characteristic is particularly important as the load is in transit from the front towards the rear of truck bed 104. Providing a pushing system in which the weight of the load is born by the rails 106 rather than by the chains 110 advantageously prevents fatigue and breakage of chains 110 as a result of the relatively large weight of the load (e.g., 40,000 lbs or more). In addition, the force required to slide the load rearwardly is significantly less than a force that would be needed to lift and then convey the heavy load rearwardly, which translates to a lower power requirement to run pusher member 108 relative to a conveyor system in which the load is lifted upwardly and then moved rearwardly.

Although illustrated with chains 110, the drive means may alternatively or additionally comprise one or more cables or belts (not shown) in combination with a hydraulic pump for driving the one or more chains, belts, and/or cables which are coupled to the pusher member. Based on the principles disclosed herein, one of skill in the art would be readily able to substitute other drive means known in the art for the chains 110. In the illustrated embodiment, the chains 110 are connected to either end of stabilizer assembly 116 and/or pusher member 108 such that chains 110 may be activated so as to pull pusher bar 108 and stabilizer assembly 116 either rearwardly (so as to push a load towards the lift platform 128 for unloading) or forwardly (to return pusher bar 108 to its initial forward position).

The inventors have discovered that a pair of heavy gauge logging drive chains (e.g., standard gauge HD81x) work particularly well in that the chains are able to bear the force associated with pulling pusher member and the palletized load without breakage or fatigue of the chains 110, even after several months or years of continued use. In addition, although chains 110 are illustrated as residing just above bed floor 104 between centrally disposed rails 106, the bed floor 104 may advantageously include a slot cut therein for receiving chains 110 along substantially their entire length so that chains 110 always or nearly always reside below bed floor 104, which may provide a safer environment for the worker relative to a configuration in which the chains 110 are raised up above the bed floor at any time. Alternatively, as in the illustrated example, the chains 110 may reside within a channel defined by centrally located rails 106, so that there is some degree of protection provided to the worker as the chains 110 are against rails 106 so as to cover at least one side of chains 110.

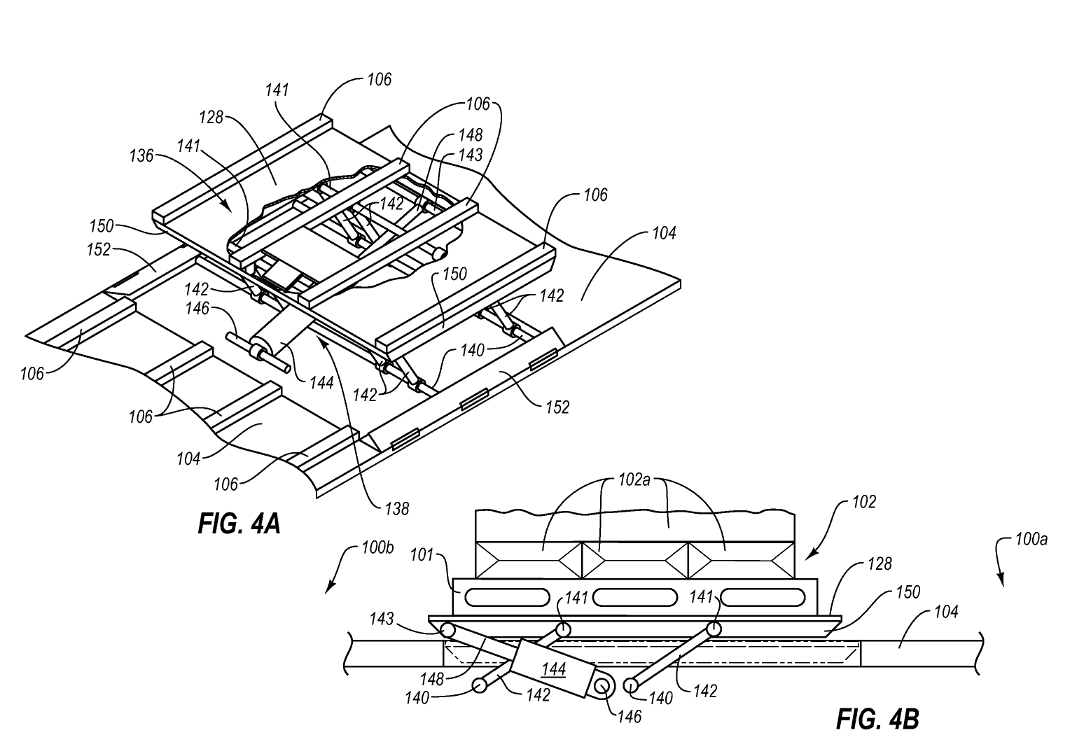

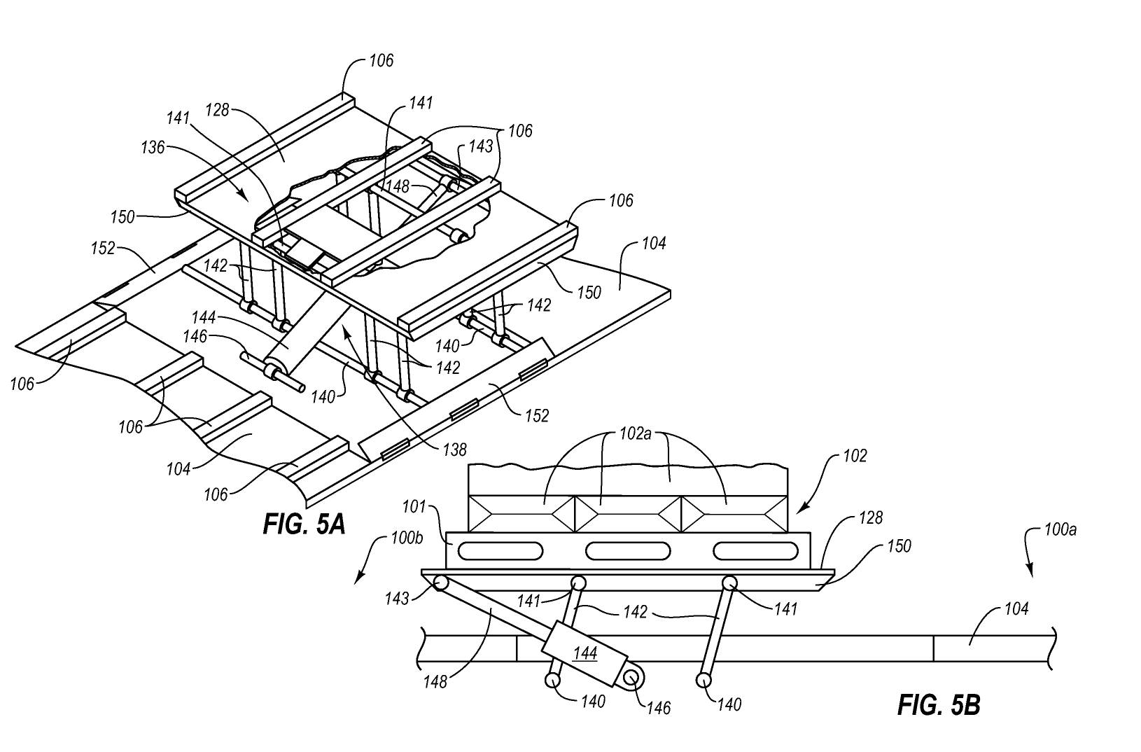

FIGS. 4A-5B show lift platform 128 in close up during operation. In FIGS. 4A and 4B, the platform 128 has been partially raised, showing how lift platform 128 raises out of bed floor 104. FIGS. 5A-5B show lift platform 128 in a fully raised position. In perspective FIGS. 4A and 5A, no load is illustrated on platform 128, and portions of the platform 128 have been cut away in order to more clearly show the parts of the lift mechanism underneath platform 128. In side views FIGS. 4B and 5B, load 102 is seen, including pallet 101 and individual packages 102a.

Lift platform 128 may be formed of the same material as bed floor 104 (e.g., diamond textured steel plate) which is connected to an undermounted lift mechanism 138. Platform 128 and lift mechanism 138 together comprise lift assembly 136, which is an example of lift means for selectively lifting a portion of the palletized load of stacked packages above the bed floor of the truck so as to facilitate unloading of individual stacked packages onto overhead conveyor 158. As illustrated, rails 106 may extend along the length of platform 128. Alternatively, rails 106 may end on bed 104 just in front of lift platform 128.

As seen in FIGS. 4A-4B, lift mechanism 138 includes a hydraulic cylinder 144 and a pair of spaced apart shafts 140 which are mounted below bed 104 so as to extend parallel to one another in a direction which is substantially perpendicular to bed floor 104. Each shaft 140 may be connected to the frame structure, which also supports bed floor 104. A plurality of rotating stabilizing lift shafts 142 are connected at one end to each shaft 140. For example, four stabilizing lift shafts 142 may be connected at one end to each shaft 140 so as to rotate about shaft 140 as lift platform 128 is raised and lowered. The opposite end of each shaft 142 is connected to the underside of lift platform 128, or to supporting structure which supports platform 128. For example, as perhaps best seen in FIG. 4B, each shaft 142 may be connected to another shaft 141 which is in turn connected to the underside of platform 128.

A front end of hydraulic cylinder 144 may be connected to another shaft 146 which is also mounted to the supporting frame structure underneath bed 104. The free end of piston 148 of cylinder 144 is connected to the underside of lift platform 128 or to structure supporting platform 128 (e.g., to rearmost bar or shaft 143). Activation of piston 148 so as to lengthen piston 148 forces stabilizing rotating shafts 142 to rotate about shafts 140 and 141, while lift platform 128 raises upwardly and rearwardly out of the plane defined by bed 104.

Hydraulic cylinder 144 is operatively coupled to the hydraulic pump (e.g., pump 134), and causes lift platform 128 to move upwardly in a cantilevered, rotating movement during operation of lift mechanism 136. In other words, as perhaps best seen in side view FIG. 4B, as lift platform 128 rises off the plane defining bed floor 104, it also moves rearwardly, towards the rear end of bed floor 104. FIG. 4B, which illustrates the location of lift platform 128 in phantom when completely lowered, illustrates this motion. The extent of this rotational, cantilevered motion is also illustrated in FIG. 5B, which illustrates the lift platform 128 and associated lift assembly 136 in a fully raised position, in which platform 128 resides rearwardly relative to its original position forward and coplanar with bed floor 104.

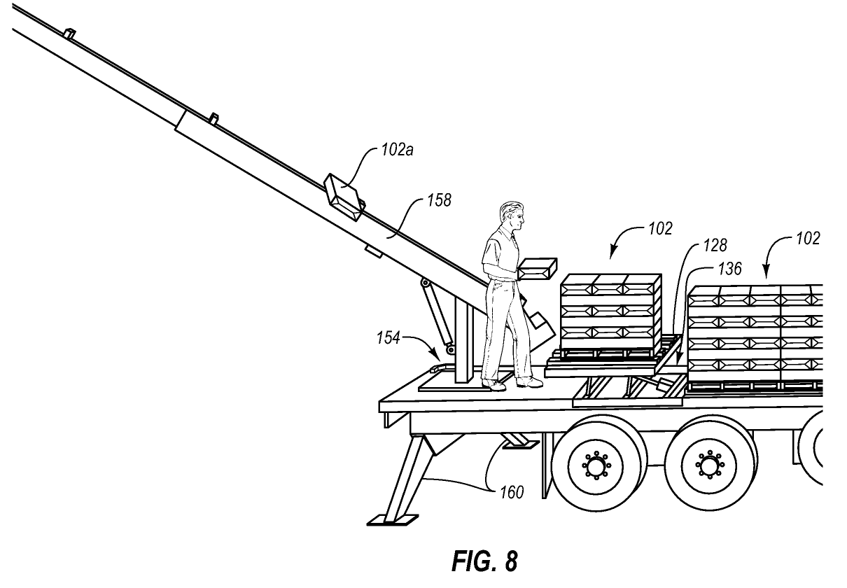

Such rearward movement of platform 128 during lifting is advantageous as it allows the pallets(s) on platform 128 to be lifted upward and outward from the remaining pallet loads 102. For example, during operation of pusher member 108, all of the pallet loads 102 are pushed rearwardly together, so that any space which originally existed between pallet loads 102 is eliminated during pushing (i.e., the front most pallet loads 102 are pushed back into the 2^{nd} most forward pallet loads, which are pushed back into the next pallet loads, and so on). Lift assembly 136 operates so as to lift the rearmost pallet loads 102 upward and rearwardly, away from the remaining pallets (see FIG. 8). Such a load may weigh up to about 10,000 lbs, although more typically about 6,000 lbs.

The lift platform assembly 136 advantageously includes a mechanism for preventing injuries to an operator's foot or other appendage as might otherwise occur while lift platform 128 is lowered, specifically in the event that an operator's foot, arm, or other appendage were to be disposed directly beneath lift platform 128. In the illustrated embodiment, safety means for preventing injuries to the operator's foot or other appendage comprises substantially vertical but inwardly beveled side walls 150 disposed on each side of lift platform 128, which side walls 150 are configured so as to push an operator's foot or other appendage out of the way as the lift platform is lowered from a raised position to a lower position. In other embodiments safety means may alternatively or additionally comprise a sensor operatively coupled to the lift mechanism, the sensor being operative to stop downward movement of the lift platform in the event that an operator's foot or other appendage is identified by the sensor as being disposed in the downward path of the lift platform. Such safety mechanisms prevent an operator's foot, arm, or other appendage from becoming caught between the lift and the bed floor, which may otherwise result in serious injury to the operator.

An additional safety feature that may be included is perhaps best seen in FIGS. 4A and 5A. Hinged arm guards 152 are illustrated as being hingedly connected to bed floor 104 to the right and left sides of lift platform 128. Arm guards 152 are formed of steel plate, and are hinged along a bottom edge to bed 104. Raising guards 152 during operation of lift platform 128 is helpful in preventing a hand or arm of an operator standing on the ground off to the side of truck bed 104 from becoming inserted between the plane of bed floor 104 and the lift platform, which may otherwise result in serious injury to the operator.

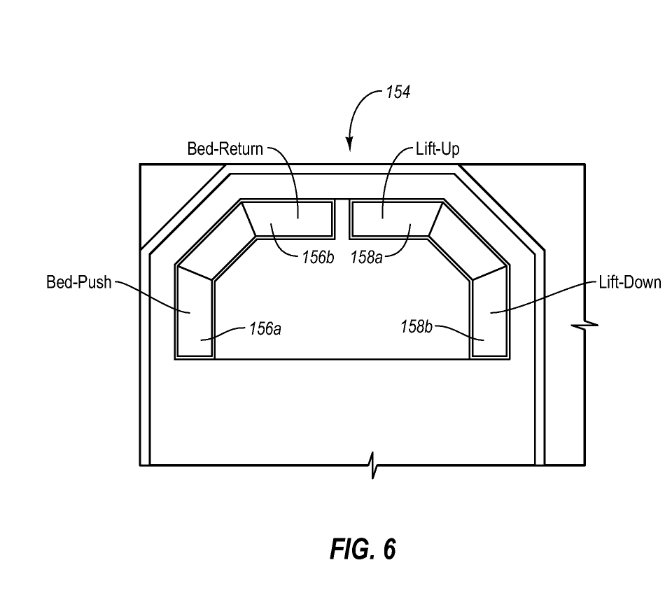

Lift platform 128 and pusher member 108 may be operated with any suitable control mechanism. FIG. 6 illustrates an exemplary foot pedal system 154 which may be advantageously mounted on bed floor 104 near a rear corner of bed 104 (FIGS. 1 and 8). Such a location advantageously allows for operation and control of both the lift platform 128 and pusher member 108 from a position near where the operator will unload the palletized packages 102a onto overhead conveyor 158. In other words, mounting the controls on bed floor 104 allows operation with a user's foot, leaving their hands free for other tasks (e.g., unloading palletized packages), and does not require that the user climb down from bed floor 104 in order to operate the pusher member 108 or lift 128 (e.g., as is required when controls are mounted on a side of the truck, below bed 104 so as to be accessible to a user from the ground. An additional set of controls may be mounted elsewhere so as to be accessible to a user who is on the ground next to the truck (e.g., mounted near the rear and below bed 104), so as to allow control of the pusher member 108 and lift from either position. The control system may advantageously lock out operation of the pusher member 108 except when lift 128 is in a fully lowered position, so as to prevent damage to lift assembly 136 if pusher member were operated when lift platform 128 were raised.

Illustrated control system 154 includes a foot pedal 156a which may be pressed by the user's foot to cause pusher member to push the load rearwardly, a pedal 156b which may be pressed to cause pusher member 108 to return towards the front of bed 104, a pedal 158a which may be pushed to raise lift platform 128, and a pedal 158b which may be pressed to lower lift platform 128.

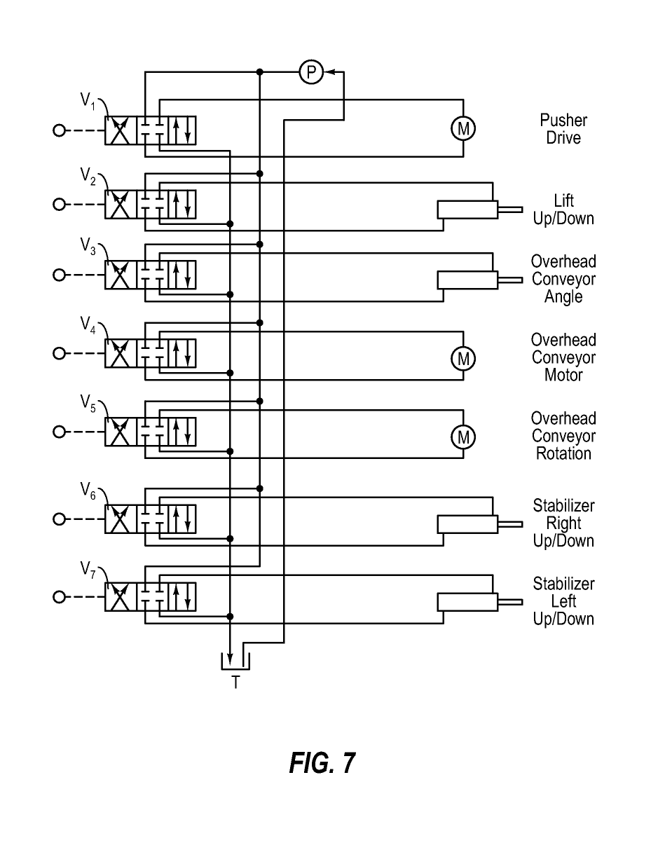

FIG. 7 schematically illustrates a hydraulic control circuit for the pusher member 108, the overhead conveyor 158, lift assembly 136, and right and left truck stabilizers 160 (FIG. 8 shows stabilizers 160 in a lowered position). A hydraulic pump P (e.g., pump 134) may be driven by a power take-off from the vehicle engine, drawing fluid from tank T and supplying hydraulic fluid under pressure to a set of control valves mounted as described above for convenient use by the operator. Valve V1 controls the direction and supply/return of hydraulic fluid under pressure to gear box 132 which drives pusher member 108. Valve V2 controls the fluid supply/return to the hydraulic cylinder 144 which operates lift platform 128. Valve V3 controls the supply/return of fluid to a hydraulic cylinder for raising and lowering overhead conveyor 158. Valve V4 controls the supply/return of fluid to a motor for driving the overhead conveyor 158. Valve V5 controls the supply/return of fluid to a turntable motor for rotating the overhead conveyor boom. Valve V6 controls the supply/return of fluid for raising or lowering a right side truck stabilizer, and valve V7 controls the supply/return of fluid for raising or lowering a left side truck stabilizer. In the case of the tandem hydraulic pump 134 described above, one side of the pump (e.g., rated at about 15 gpm) may be used to power the pusher member 108, the lift 128, and stabilizers 160 (valves V1, V2, V6 and V7). The other side of the pump (e.g., rated at 6-8 gpm) may be used to power the overhead conveyor (valves V3, V4, and V5).

FIG. 8 illustrates a user unloading packages 102a from palletized loads 102, and placing the individual packages onto overhead conveyor 158. One such preferred overhead conveyor which is non-conductive so as to reduce the risk of electrocution as the result of contacting a power line with the overhead conveyor 158 is disclosed in U.S. Pat. No. 5,984,077, herein incorporated by reference.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A bed conveyor for use with a motorized vehicle for transporting palletized loads of stacked packages and delivering the packages by means of an overhead conveyor to a location remote from the truck, the bed conveyor comprising:
a plurality of spaced apart rails, each having a first end and a second end, the rails extending longitudinally along a bed floor of the vehicle, the rails defining a top weight bearing surface for supporting the weight of a plurality of palletized loads of stacked packages;
a pusher member at least partially disposed above the top surface of the plurality of rails, the pusher member being selectively movable between a first position near the first end of the plurality of rails and a second position located rearwardly relative to the first position; and
drive means operatively coupled to the pusher member for selectively moving the pusher member between the first and second positions, the drive means being spaced apart from the top weight bearing surface of the plurality of rails such that the weight of palletized loads of stacked packages is primarily supported by the plurality of rails rather than the drive means.

2. A bed conveyor as recited in claim 1, wherein the drive means comprises one or more chains, belts or cables coupled to the pusher member and a hydraulic pump operatively coupled to drive the one or more chains, belts, or cables.

3. A bed conveyor as recited in claim 2, wherein the drive means comprises a pair of chains centrally disposed between two of the plurality of rails extending longitudinally along the bed floor.

4. A bed conveyor as recited in claim 3, wherein each chain comprises an HD81x standard heavy duty logging chain.

5. A bed conveyor as recited in claim 2, wherein the hydraulic pump is selectively operable to move the pusher member at a rate between about 10 and about 60 feet per minute.

6. A bed conveyor as recited in claim 2, wherein the hydraulic pump is selectively operable to move the pusher member at a rate between about 15 and about 40 feet per minute.

7. A bed conveyor as recited in claim 2, wherein the hydraulic pump is selectively operable to move the pusher member at a rate between about 20 and about 30 feet per minute.

8. A bed conveyor as recited in claim 2, wherein the hydraulic pump comprises a dual valve tandem hydraulic pump configured to provide a flow rate of about 15 gpm on one side and a flow rate of about 6-8 gpm on another side.

9. A bed conveyor as recited in claim 1, wherein the pusher member comprises a rectangular bar, the bed conveyor further comprising a stabilizer assembly to which the pusher member is connected, the stabilizer assembly sliding between two of the plurality of rails extending longitudinally along the bed floor so as to help in maintaining the pusher member substantially perpendicular to the rails.

10. A motorized vehicle for transporting palletized loads of stacked packages and delivering the packages by means of an overhead conveyor to a location remote from the truck, the vehicle having a bed floor for supporting palletized loads of stacked packages, the vehicle including:
a bed conveyor comprising:
a plurality of rails, each having a first end and a second end, the rails extending longitudinally along the bed floor, the rails defining a top weight bearing surface for supporting the weight of a plurality of palletized loads of stacked packages;
a pusher member disposed at least partially above the top surface of the plurality of rails, the pusher member being selectively movable between a first position near the first end of the plurality of rails and a second position located rearwardly relative to the first position; and
drive means operatively coupled to the pusher member for selectively moving the pusher member between the first and second positions, the drive means being spaced apart from the top weight bearing surface of the plurality of rails such that the weight of the palletized loads of stacked packages is primarily supported by the plurality of rails rather than the drive means; and
a lift assembly disposed at a transfer station near the rear of the bed floor, the lift assembly comprising:
a lift platform that is selectively movable from a lower position generally coplanar with the bed floor to a raised position above the bed floor;
a lift mechanism disposed under the lift platform for moving the lift platform between a lowered position and a raised position; and
safety means for preventing injuries to an operator's foot while operating the lift assembly.

11. A motorized vehicle as recited in claim 10, wherein the safety means for preventing injuries to an operator's foot comprises substantially vertical side walls disposed on the lift platform, the side walls being inwardly beveled so as to push an operator's foot away as the lift platform is lowered from a raised position to a lower position.

12. A motorized vehicle as recited in claim 10, wherein the safety means for preventing injuries to an operator's foot comprises a sensor operatively coupled to the lift mechanism, the sensor being operative to stop downward movement of the lift platform in response to an operator's foot being disposed directly beneath the lift platform.

13. A motorized vehicle as recited in claim 10, further comprising two hinged arm guards disposed on the bed floor on either side of the lift platform so as to prevent a user from inserting a hand or arm between the lift platform and the bed floor while the arm guards are raised.

14. A motorized vehicle as recited in claim 10, further comprising an overhead conveyor supported near a rear end of the bed floor and arranged to selectively extend outward of the bed floor over a range of elevations and directions.

15. A motorized vehicle as recited in claim 10, wherein the drive means comprises one or more chains, belts or cables coupled to the pusher member and a hydraulic pump operatively coupled to drive the one or more chains, belts, or cables.

16. A motorized vehicle as recited in claim 15, wherein the drive means comprises a pair of chains centrally disposed between two of the plurality of rails extending longitudinally along the bed floor.

17. A motorized vehicle as recited in claim 15, wherein the hydraulic pump comprises a dual valve tandem hydraulic pump configured to provide a flow rate of about 15 gpm on one side and a flow rate of about 6-8 gpm on another side.

18. A motorized vehicle as recited in claim 10, wherein the pusher member comprises a rectangular bar, the motorized vehicle further comprising a stabilizer assembly to which the pusher member is connected, the stabilizer assembly sliding between two of the plurality of rails extending longitudinally along the bed floor so as to help in maintaining the pusher member substantially perpendicular to the rails.

19. A motorized vehicle as recited in claim 10, wherein the lift mechanism is configured to simultaneously lift the lift platform upwardly and rearwardly relative to the bed floor.

20. A truck for transporting palletized loads of stacked packages and delivering the packages by means of an overhead conveyor to a location remote from the truck, the truck having a bed floor for supporting palletized loads of stacked packages, the truck comprising:
a bed conveyor comprising;
a plurality of rails, each having a first end and a second end, the rails extending longitudinally along the bed floor, the rails defining a top weight bearing surface for supporting the weight of a plurality of palletized loads of stacked packages;
pusher means for pushing the plurality of palletized loads of stacked packages between a first position near the first end of the plurality of rails and a second position located rearwardly relative to the first position; and
lift means for selectively lifting a portion of the palletized load of stacked packages above the bed floor of the truck so as to facilitate unloading of individual stacked packages onto an overhead conveyor, said lift means being disposed at or near the second end of the plurality of rails.

21. A truck as recited in claim 20, wherein the lift means comprises:
a lift platform that is selectively movable from a lower position generally coplanar with the bed floor to a raised position above the bed floor;
a lift mechanism disposed under the lift platform for moving the lift platform between a lowered position and a raised position; and
substantially vertically extending side walls disposed under the lift platform, the side walls being inwardly beveled so as to push an operator's foot away as the lift platform is lowered from a raised position to a lower position.
